(19) United States
(12) Patent Application Publication
(10) Pub. No.: US 2026/0017026 A1
(43) Pub. Date: Jan. 15, 2026

(54) METHOD, APPARATUS, DEVICE AND STORAGE MEDIUM FOR CREATING APPLICATION

(71) Applicant: Beijing Zitiao Network Technology Co., Ltd., Beijing (CN)

(72) Inventor: Xuneng HUANG, Beijing (CN)

(21) Appl. No.: 18/986,119

(22) Filed: Dec. 18, 2024

(30) Foreign Application Priority Data
Jul. 9, 2024 (CN) 202410918040.8

(51) Int. Cl. G06F 8/30

(52) U.S. Cl. CPC G06F 8/30

(57) ABSTRACT

Embodiments of the disclosure relate to methods, apparatuses, devices and storage mediums for creating an application. An example method includes: displaying, based on a selection of a target application creation mode, an application edit interface comprising a workflow configuration component; adding a target workflow via the workflow configuration component, the target workflow comprising a plurality of processing nodes; and creating a target application based on the target workflow, wherein a starting node of the plurality of processing nodes is configured to directly process a user request received by the target application to determine a preset parameter in the target workflow.

### CROSS-REFERENCE TO RELATED APPLICATIONS

This application claims priority to Chinese Patent Application No. 202410918040.8, filed on Jul. 9, 2024, which is hereby incorporated by reference in its entirety.

### TECHNICAL FIELD

Example embodiments of the disclosure generally relate to the field of computers, and more particularly, to methods, apparatuses, devices, and computer-readable storage media for creating an application.

### BACKGROUND

With the development of computer technology, one may create and publish various types of applications through some platforms. For example, with the development of machine learning techniques, one may quickly create applications by configuring parameters of the application, such as models used by the application, available plug-ins, and so on.

### SUMMARY

In a first aspect of the disclosure, a method for creating an application is provided. The method comprises: displaying, based on a selection of a target application creation mode, an application edit interface comprising a workflow configuration component; adding a target workflow via the workflow configuration component, the target workflow comprising a plurality of processing nodes; and creating a target application based on the target workflow, wherein a starting node of the plurality of processing nodes is configured to directly process a user request received by the target application to determine a preset parameter in the target workflow.

In a second aspect of the disclosure, an apparatus for creating an application is provided. The apparatus comprises: a display module configured to display, based on a selection of a target application creation mode, an application edit interface comprising a workflow configuration component; an addition module configured to add a target workflow via the workflow configuration component comprising a plurality of processing nodes; and a creation module configured to create a target application based on the target workflow, wherein a starting node of the plurality of processing nodes is configured to directly process a user request received by the target application to determine a preset parameter in the target workflow.

In a third aspect of the disclosure, an electronic device is provided. The electronic device comprises at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the disclosure, a computer readable storage medium is provided. The computer readable storage medium stores thereon a computer program that, when executed by a processor, implements the method of the first aspect.

It should be appreciated that what is described in this Summary is not intended to limit critical features or essential features of embodiments of the disclosure, nor is it intended to limit the scope of the disclosure. Other features of the disclosure will become readily appreciated from the following description.

### BRIEF DESCRIPTION OF THE DRAWINGS

The above and other features, advantages, and aspects of various embodiments of the disclosure will become more apparent with reference to the following detailed description taken in conjunction with the accompanying drawings. In the drawings, the same or similar reference numerals represent the same or similar elements, wherein:

FIG. 1 illustrates a schematic diagram of an example environment in which embodiments of the disclosure may be implemented;

FIG. 2 illustrates a flow diagram of an example process of creating an application according to some embodiments of the disclosure;

FIGS. 3A-3C illustrate some example interfaces according to some embodiments of the present disclosure;

FIG. 4 illustrates a schematic structural block diagram of an example apparatus for creating an application according to some embodiments of the disclosure; and

FIG. 5 illustrates a block diagram of an electronic device capable of implementing various embodiments of the disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of the present disclosure.

It should be noted that the titles of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “comprise” and the like should be understood as open-ended including, that is, “include but is not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the present disclosure may relate to data of a user, acquisition and/or use of data, etc., all following respective legal regulations and related regulations. In embodiments of the present disclosure, the collection, acquisition, processing, treatment, forwarding, use, and the like, of the data are all made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific manner of informing and/or authorization may vary according to actual situations and application scenarios, and the scope of the present disclosure is not limited in this aspect.

The solution in the present description and the embodiments, if involves the personal information, is performed on the basis of legitimacy (for example, the consent of the personal information body is obtained, or necessary for fulfillment of a contract, etc.), and is performed only within a preset range or a prescribed range. The user's refusal to process personal information other than the necessary information required for the basic function will not affect the user's use of the basic function.

Conventionally, a user may use the models used for configuring an application, plug-ins, and the like to quickly create an application, for example, a bot. In some scenarios, an application, such as a bot, may configure a workflow that can be invoked. The bot can, for example, handle specific tasks by invoking workflows. However, the trigger of such workflow has a strong uncertainty, resulting in instability in the quality of task processing.

The embodiments of the disclosure provide a solution for creating an application. According to the solution, an application edit interface comprising a workflow configuration component is displayed, based on a selection of a target application creation mode. Further, a target workflow may be added via the workflow configuration component, where the target workflow comprises a plurality of processing nodes. Accordingly, a target application may be created based on the target workflow, wherein a starting node of the plurality of processing nodes is configured to directly process a user request received by the target application to determine a preset parameter in the target workflow.

Based on the above-described process, the embodiments of the disclosure can create a workflow-based application, and ensure that a workflow is invoked during each processing process, thereby improving the quality of request processing.

Various example implementations of the solution are described in further detail below with reference to the accompanying drawings.

### Example Environment

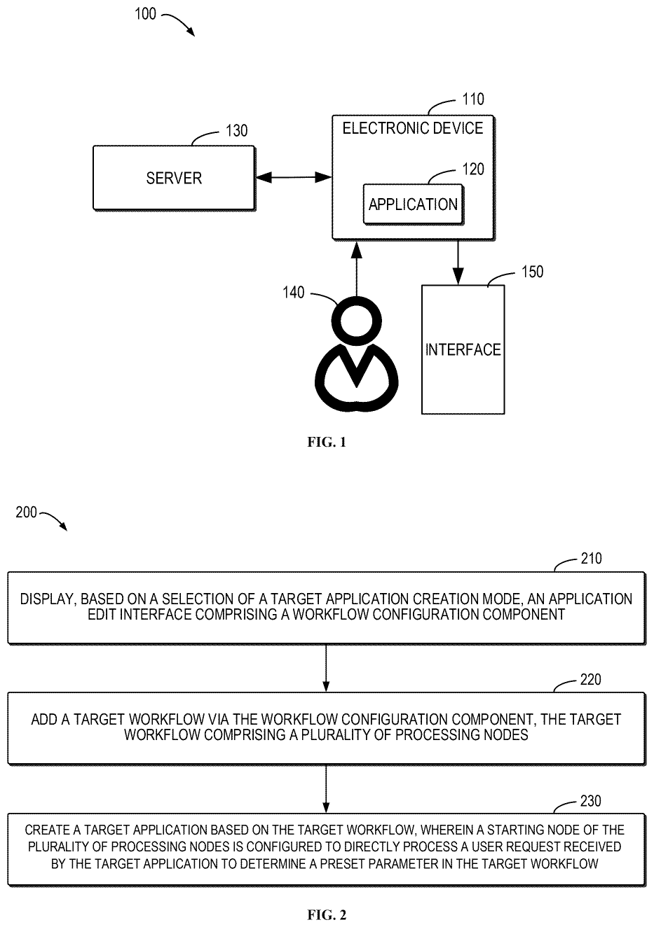

FIG. 1 shows a schematic diagram of an example environment 100 in which embodiments of the present disclosure can be implemented. As shown in FIG. 1, the example environment 100 may comprise an electronic device 110.

In this example environment 100, the electronic device 110 may run an application 120 that supports interface interaction. The application 120 may be any suitable type of application for interface interaction, examples of which may include, but are not limited to, a development application or other suitable application that supports application development. The user 140 may interact with application 120 via the electronic device 110 and/or an attached device thereof.

In the environment 100 of FIG. 1, if the application 120 is active, the electronic device 110 may present an interface 150 for supporting the creation of an application through the application 120.

In some embodiments, the electronic device 110 communicates with the server 130 to enable the provision of services to application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. In some embodiments, the electronic device 110 can also support any type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. Server 130 may include, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. The communication connection may include, but is not limited to, Bluetooth connection, mobile network connection, Universal Serial Bus (USB) connection, Wireless Fidelity (WiFi) connection, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for illustrative purposes only, and are not intended to imply any limitation on the scope of the disclosure.

Some example embodiments of the present disclosure will be described below with continued reference to the accompanying drawings.

### Example Application Creation Process

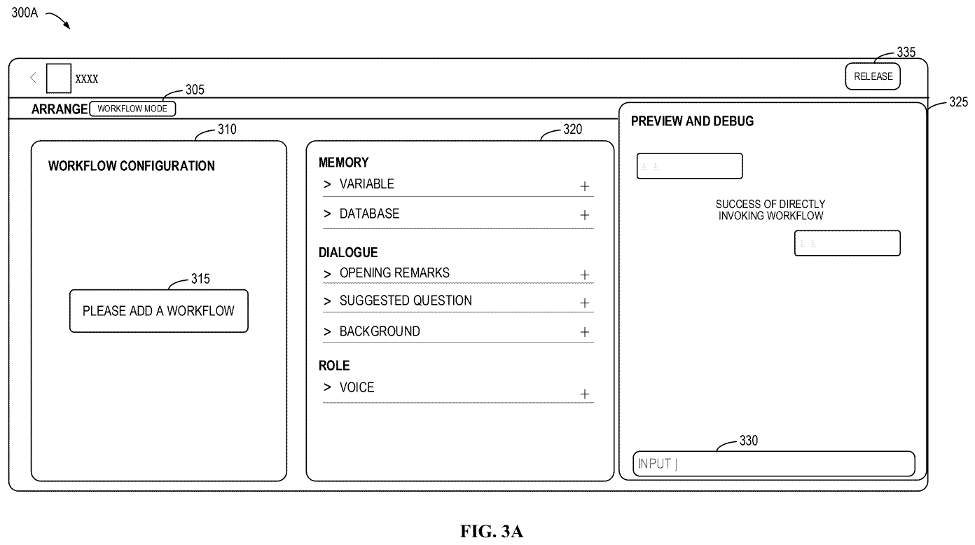

FIG. 2 illustrates a flowchart of a process 200 of creating an application according to some embodiments of the disclosure. The process 200 may be implemented at the electronic device 110. The process 200 is described below with reference to FIG. 1.

At block 210, the electronic device 110 displays an application edit interface based on the selection of the target application creation mode, wherein the application edit interface comprises a workflow configuration component.

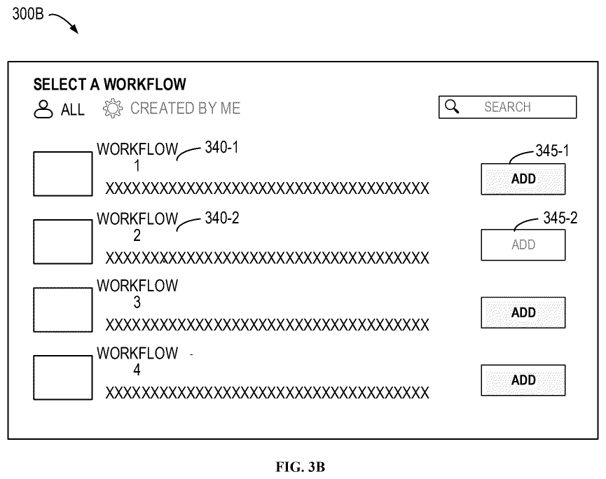

FIG. 3A illustrates an example interface 300A according to some embodiments of this disclosure. The interface 300A is an application edit interface provided by the electronic device 110.

By way of example, the electronic device 110 may receive the user's selection of a target application creation mode (e. g., a workflow mode) via the control 305, and may present an application edit interface correspondingly as shown in FIG. 3A.

In some embodiments, the electronic device 110 may also support a user to create an application via other creation modes. For example, the electronic device 110 may support a user to create a bot based on a single agent, or create a bot based on multiple agents, and the like.

In the target application creation mode, the interface 300A may provide a plurality of components, as illustrated in FIG. 3A. In particular, the interface 300A may comprise a workflow configuration component 310, a parameter configuration component 320, and a debugging component 325. Specific details regarding the components will be described in detail below.

At block 220, the electronic device 110 adds a target workflow via the workflow configuration component, wherein the target workflow comprises a plurality of processing nodes.

As shown in FIG. 3A, the electronic device 110 may provide the workflow configuration component 310 in the interface 300A, and may display an addition entry 315. In some embodiments, the electronic device 110 may receive preset operations for the workflow configuration component 310 (e. g., the selection of the addition entry 315), and may present the window as shown in FIG. 3B accordingly.

As shown in FIG. 3B, the electronic device 110 may present a set of candidate workflows, e. g., a workflow 340-1, a workflow 340-2, and the like. Further, the electronic device 110 may receive a selection of a target workflow (e. g., the workflow 340-1) from the user (for example, a selection of an addition control 345-1), and may accordingly display the added target workflow in the interface 300A, for example, to associate the workflow 340-1 to an application to be created.

In some embodiments, the workflows presented in the window 300B may comprise a plurality of workflows to which the current user has access. Additionally, the electronic device 110 may determine whether the respective workflow matches the target application creation mode (i. e., workflow mode).

In some examples, only workflow whose starting node meets a preset condition is allowed to be added. For example, the starting node of the workflow 340-1 may read user input message and save it as a variable in the workflow, but the starting node of the workflow 340-2 does not have the ability to read user input message.

In this case, for example, the workflow 340-1 may match the target application creation mode, and the workflow 340-2 may not match the target application creation mode. Accordingly, the electronic device 110 may provide an addition control 345-1 for adding workflow 340-1, and may disable the addition control 345-2 corresponding to workflow 340-2.

In some embodiments, the electronic device 110 may further provide a creation entry in the workflow configuration component 310 (or a triggered window), for example. The electronic device 110 may present a workflow edit interface for creating a workflow based on the selection of the creation entry. Moreover, the electronic device 110 may add a workflow created via the workflow edit interface.

In some embodiments, an added existing workflow or a newly created workflow may have a plurality of processing nodes. It should be appreciated that the workflow may be edited in any suitable manner.

In some embodiments, for the target application creation mode, the starting node of the target workflow may be configured to directly process a user request received by the created target application. As shown in FIG. 3C, the electronic device 110 may provide a configuration window 300C for the starting node.

As shown in FIG. 3C, the electronic device 110 may set the starting node to be configured with one or more parameters (or variables) extracted based on the received user request (e. g., user input message), such as the parameter 350 and the parameter 355.

In some embodiments, the parameter 350 may be, for example, a required parameter that may be used, for example, to store message content inputted by the user and may be passed to other appropriate nodes in the workflow through the variable ‘USER_INPUT’ for subsequent processing flows.

In some embodiments, the electronic device 110 may also define the parameters 355 that need to be extracted based on the user request according to the user's configuration operation. The electronic device 110 may obtain configuration information regarding the parameter 355. The configuration information may indicate the type of the parameter 355, the description content, and whether the parameter 355 must be extracted, etc.

As an example, the electronic device 110 may further add the parameters to be extracted based on the received user request according to the user's selection of the control 360.

With continued reference to FIG. 3A, after the addition of the target workflow is completed, the electronic device 110, for example, may update the workflow configuration component 310 to display the added target workflow.

Additionally, the electronic device 110 may provide a parameter configuration component 320 to obtain a set of configuration information. In some embodiments, the set of configuration information obtained via the parameter configuration component 320 is associated with the running process of the target workflow. For example, the set of configuration information may comprise a memory parameter associated with the target workflow, such as a variable parameter and a database parameter, etc. By configuring the memory parameter, the target workflow may access and update the defined variables and/or databases, for example, during runtime.

Additionally, such a set of configuration information may further comprise one or more dialog parameters, such as the opening remarks of the target application, the suggested question displayed by the target application, the background style of the message area of the target application, and the like. Alternatively, such a set of configuration information may further comprise voice parameters to set the voice style of the voice content provided by the target application.

With continued reference to FIG. 2, at block 230, the electronic device 110 creates a target application based on the target workflow, wherein a starting node of the plurality of processing nodes is configured to directly process the user request received by the target application to determine a preset parameter in the target workflow.

As shown in FIG. 3A, the electronic device 110 may obtain configuration information for an application via interface 300A, and may create a corresponding application based on a selection of a release control 335. Such applications may comprise, for example, an agent, a bot, etc. Further, the created agent or bot may be released or shared to other users, for example.

In some embodiments, with the permission of a releaser, for example, other users may also be supported to create a template of a released application, and create a new application by editing corresponding configuration information, thereby the efficiency of an application can be improved.

In some embodiments, as shown in FIG. 3A, the electronic device 110 may also support, for example, debugging a target application to be released via debugging component 325. For example, the electronic device 110 may simulate inputting a particular message into a target application via the input control 330, and may view the processing results of the target application for the particular message through the debugging component 325.

In some embodiments, upon receiving a user request, the target application may provide the user request directly to the starting node in the target workflow to trigger the starting node to process the user request. In particular, as introduced above, the starting node may determine one or more preset parameters, e. g., the parameter 350 and/or the parameter 355 described above, based on the user request.

In some embodiments, a parameter (e. g., the parameters 350) may be configured as a required parameter. Accordingly, if the starting node fails to determine the parameter from the user request, the starting node may further provide an inquiry message to the user to obtain the user's response content. Further, the starting node may determine the parameter 350 based on the received response content.

In some embodiments, such an inquiry and response process may be performed up to predetermine rounds. In some embodiments, if the starting node still fails to determine the parameter based on the user inputted message within the preset rounds, the target application may trigger execution of the next processing node in the target workflow, or the target application may stop responding to the user's request.

Upon receiving the user request, the target application may no longer consider the specific intent of the user request, and may always trigger the starting node to process the user request. In this way, the target application may ensure that the target workflow can always be triggered.

In some embodiments, a model processing node associated with a machine learning model (e. g., a language model) may also be included in the target workflow, for example. Further, in the edit interface of the target workflow, the electronic device 110 may further provide a configuration window for the model processing node. Additionally, the electronic device 110 may associate the reference application to the target workflow via a context configuration control in the configuration window.

For example, the electronic device 110 may support associating other appropriate bots to the target workflow. Thus, during debugging or execution of the target application, contextual information (e. g., dialog messages in a bot) associated with the reference application (e. g., the bot) may be provided to the target model corresponding to the model processing node, such that the target model may process a task based on the contextual information.

Based on the above-described process, the embodiments of the disclosure can support creating a workflow-based application, and ensure that a workflow is invoked during each processing process, thereby improving the quality of request processing.

### Example Apparatus and Device

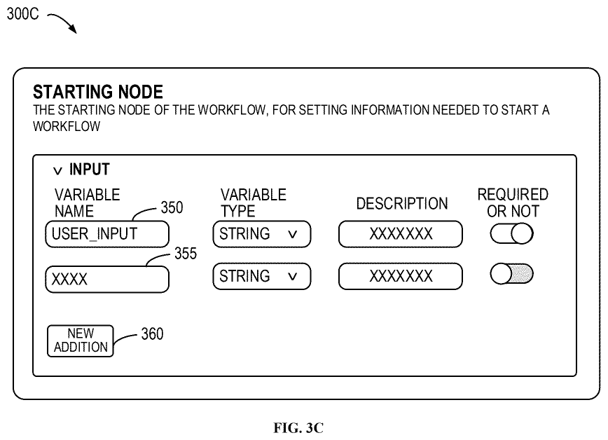

Embodiments of the disclosure further provide corresponding apparatus for implementing the method or process described above. FIG. 4 illustrates a schematic structural block diagram of an example apparatus 400 for creating an application, in accordance with some embodiments of the disclosure. The apparatus 400 may be implemented as or included in an electronic device 110. The various modules/components in the apparatus 400 may be implemented by hardware, software, firmware, or any combination thereof.

As shown in FIG. 4, the apparatus 400 comprises: a display module 410 configured to display, based on a selection of a target application creation mode, an application edit interface comprising a workflow configuration component; an addition module 420 configured to add a target workflow via the workflow configuration component comprising a plurality of processing nodes; and a creation module 430 configured to create a target application based on the target workflow, wherein a starting node of the plurality of processing nodes is configured to directly process a user request received by the target application to determine a preset parameter in the target workflow.

In some embodiments, the display module 410 is further configured to: present a set of candidate workflows based on a preset operation on the workflow configuration component; and add the target workflow in response to a selection of the target workflow in the set of candidate workflows.

In some embodiments, the apparatus 400 further comprises a control presenting module, which is configured to, in response to at least one workflow of the set of candidate workflows matching the target application creation mode, present an addition control corresponding to the at least one workflow.

In some embodiments, the display module 410 is further configured to: present a workflow edit interface based on a selection of a creation entry in the workflow configuration component; and add the target workflow created via the workflow edit interface.

In some embodiments, the starting node is further configured to: in response to a failure to determine the preset parameter from the user request, provide an inquiry message; and receive response content for the inquiry message to determine the preset parameter based on the response content.

In some embodiments, the apparatus 400 further comprises a configuration information obtaining module, which is configured to: obtain, via the application edit interface, a set of configuration information associated with a running process of the target workflow.

In some embodiments, the set of configuration information indicates a memory parameter associated with the target workflow.

In some embodiments, the apparatus 400 further comprises a control providing module, which is configured to: provide a context configuration control in a configuration window of the model processing node; and associate a reference application to the target workflow based on the context configuration control, to cause contextual information associated with the reference application to be provided to a target model corresponding to the model processing node.

In some embodiments, the target application is configured to: in response to receiving the user request, trigger the starting node to process the user request independent of an intent of the user request.

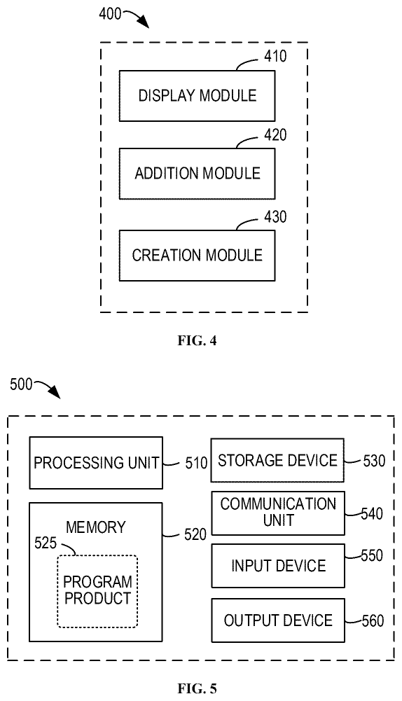

FIG. 5 illustrates a block diagram of an electronic device 500 in which one or more embodiments of the present disclosure may be implemented. It should be appreciated that the electronic device 500 shown in FIG. 5 is merely illustrative and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general electronic device. The components of the electronic device 500 may comprise, but are not limited to, one or more processors or processing units 510, memory 520, storage 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units executes computer executable instructions in parallel to improve the parallel processing capability of the electronic device 500.

The electronic device 500 typically comprises a plurality of computer storage media. Such media may be any available media that is accessible to the electronic device 500, including, but not limited to, volatile and non-volatile media, removable and non-removable media. The memory 520 may be a volatile memory (e. g., register, cache, random access memory (RAM)), a non-volatile memory (e. g., read-only memory (ROM), electrically erasable programmable read-only memory (EEPROM), flash memory), or some combination thereof. The storage 530 may be a removable or non-removable medium, and may include a machine-readable medium such as a flash drive, a magnetic disk, or any other medium that may be used to store information and/or data and that may be accessed within the electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may comprise a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown), such as storage devices, display devices, etc., as needed through the communication unit 540, with one or more devices that enable a user to interact with the electronic device 500, or with any device (e. g., network card, modem, etc.) that enables the electronic device 500 to communicate with one or more other electronic devices. Such communication may be performed via an input/output (I/O) interface (not shown).

According to an example implementation of the present disclosure, a computer-readable storage medium is provided, on which computer-executable instructions are stored, wherein the computer-executable instructions are executed by a processor to implement the above-described method. According to an example implementation of the present disclosure, there is also provided a computer program product, which is tangibly stored on a non-transitory computer-readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowchart and/or block diagrams, and combinations of blocks in the flowchart and/or block diagrams, can be implemented by computer-readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce means for implementing the functions/acts specified in one or more blocks of the flowchart and/or block diagram. These computer-readable program instructions may also be stored in a computer-readable storage medium. These instructions can direct a computer, programmable data processing apparatus, and/or other devices to function in a particular manner, such that the computer-readable medium storing the instructions comprises an article of manufacture, which includes instructions that implement various aspects of the functions/acts specified in one or more blocks of the flowchart and/or block diagram.

The computer readable program instructions may be loaded onto a computer, other programmable data processing apparatus, or other devices, causing a series of operational steps to be performed on a computer, other programmable data processing apparatus, or other devices, to produce a computer implemented process, such that the instructions which execute on the computer, other programmable data processing apparatus, or other devices implement the functions/acts specified in one or more blocks of the flowchart and/or block diagram.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, a program segment, or a portion of instructions which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, can be implemented by special purpose hardware-based systems that perform the specified functions or acts, or combinations of special purpose hardware and computer instructions.

Having described implementations of the disclosure above, the foregoing description is illustrative, not exhaustive, and is not limited to the implementations disclosed. Many modifications and variations will be apparent to those of ordinary skill in the art without departing from the scope and spirit of the implementations described. The selection of terms used herein is intended to best explain the principles of the implementations, the practical application, or improvements to technologies in the market, or to enable others of ordinary skill in the art to understand the implementations disclosed herein.

What is claimed is:

1. A method for creating an application, comprising:
displaying, based on a selection of a target application creation mode, an application edit interface comprising a workflow configuration component;
adding a target workflow via the workflow configuration component, the target workflow comprising a plurality of processing nodes; and
creating a target application based on the target workflow, wherein a starting node of the plurality of processing nodes is configured to directly process a user request received by the target application to determine a preset parameter in the target workflow.

2. The method of claim 1, wherein adding the target workflow via the workflow configuration component comprises:
presenting a set of candidate workflows based on a preset operation on the workflow configuration component; and
adding the target workflow in response to a selection of the target workflow in the set of candidate workflows.

3. The method of claim 2, further comprising:
in response to at least one workflow of the set of candidate workflows matching the target application creation mode, presenting an addition control corresponding to the at least one workflow.

4. The method of claim 1, wherein adding the target workflow via the workflow configuration component comprises:
presenting a workflow edit interface based on a selection of a creation entry in the workflow configuration component; and
adding the target workflow created via the workflow edit interface.

5. The method of claim 1, wherein the starting node is further configured to:
in response to a failure to determine the preset parameter from the user request, provide an inquiry message; and
receiving response content for the inquiry message to determine the preset parameter based on the response content.

6. The method of claim 1, further comprising:
obtaining, via the application edit interface, a set of configuration information associated with a running process of the target workflow.

7. The method of claim 6, wherein the set of configuration information indicates a memory parameter associated with the target workflow.

8. The method of claim 1, wherein the plurality of processing nodes comprises a model processing node, the method further comprises:
providing a context configuration control in a configuration window of the model processing node; and
associating a reference application to the target workflow based on the context configuration control, to cause contextual information associated with the reference application to be provided to a target model corresponding to the model processing node.

9. The method of claim 1, wherein the target application is configured to:
in response to receiving the user request, trigger the starting node to process the user request independent of an intent of the user request.

10. An electronic device, comprising:
at least one processing unit; and
at least one memory coupled to the at least one processing unit and storing instructions for execution by the at least one processing unit that, when executed by the at least one processing unit, cause the electronic device to perform operations comprising:
displaying, based on a selection of a target application creation mode, an application edit interface comprising a workflow configuration component;
adding a target workflow via the workflow configuration component comprising a plurality of processing nodes; and
creating a target application based on the target workflow, wherein a starting node of the plurality of processing nodes is configured to directly process a user request received by the target application to determine a preset parameter in the target workflow.

11. The electronic device of claim 10, wherein adding the target workflow via the workflow configuration component comprises:
presenting a set of candidate workflows based on a preset operation on the workflow configuration component; and
adding the target workflow in response to a selection of the target workflow in the set of candidate workflows.

12. The electronic device of claim 11, wherein the operations comprise:
in response to at least one workflow of the set of candidate workflows matching the target application creation mode, presenting an addition control corresponding to the at least one workflow.

13. The electronic device of claim 10, wherein adding the target workflow via the workflow configuration component comprises:
presenting a workflow edit interface based on a selection of a creation entry in the workflow configuration component; and
adding the target workflow created via the workflow edit interface.

14. The electronic device of claim 10, wherein the starting node is further configured to:
in response to a failure to determine the preset parameter from the user request, provide an inquiry message; and
receiving response content for the inquiry message to determine the preset parameter based on the response content.

15. The electronic device of claim 10, wherein the operations comprise:
obtaining, via the application edit interface, a set of configuration information associated with a running process of the target workflow.

16. The electronic device of claim 15, wherein the set of configuration information indicates a memory parameter associated with the target workflow.

17. The electronic device of claim 10, wherein the plurality of processing nodes comprises a model processing node, the apparatus further comprises:
providing a context configuration control in a configuration window of the model processing node; and
associating a reference application to the target workflow based on the context configuration control, to cause contextual information associated with the reference application to be provided to a target model corresponding to the model processing node.

18. The electronic device of claim 10, wherein the target application is configured to:
in response to receiving the user request, trigger the starting node to process the user request independent of an intent of the user request.

19. A non-transitory computer readable storage medium storing one or more instructions executable by a computer system to perform operations comprising:
displaying, based on a selection of a target application creation mode, an application edit interface comprising a workflow configuration component;
adding a target workflow via the workflow configuration component, the target workflow comprising a plurality of processing nodes; and
creating a target application based on the target workflow, wherein a starting node of the plurality of processing nodes is configured to directly process a user request received by the target application to determine a preset parameter in the target workflow.

20. The non-transitory computer readable storage medium of claim 19, wherein adding the target workflow via the workflow configuration component comprises:
presenting a set of candidate workflows based on a preset operation on the workflow configuration component; and
adding the target workflow in response to a selection of the target workflow in the set of candidate workflows.
